(19) United States
(12) Patent Application Publication
(10) Pub. No.: US 2013/0246562 A1
(43) Pub. Date: Sep. 19, 2013

(54) SYSTEMS AND METHODS FOR MANAGING CONTENT

(71) Applicants: James CHONG, Singapore (SG); Shaikh ISMAIL s/o Sathakuthamby, Singapore (SG); Renneth WIJAYA, Singapore (SG); Chia Her SAN, Singapore (SG); Kuo Pin NG, Singapore (SG)

(72) Inventors: James CHONG, Singapore (SG); Shaikh ISMAIL s/o Sathakuthamby, Singapore (SG); Renneth WIJAYA, Singapore (SG); Chia Her SAN, Singapore (SG); Kuo Pin NG, Singapore (SG)

(73) Assignee: ACCENTURE GLOBAL SERVICES LIMITED, Dublin (IE)

(21) Appl. No.: 13/420,455

(22) Filed: Mar. 14, 2012

(51) Int. Cl. G06F 15/16

(52) U.S. Cl. 709/217

(57) ABSTRACT

In systems and methods for managing content, a code associated with a first content is received at a computing node from a first device and is stored in a profile at the computing node. A plurality of other computing nodes are searched for one or more additional content associated with the code based on the first content. Content identifiers associated with the one or more additional content are stored in the profile and in a content table which associates the code with each of the content identifiers. Each of the content identifiers stored in the profile are organized based on the profile, and a rendering of the organized content identifiers is provided to a second device. The one or more additional content is sent to the second device in response to a selection of at least one of the content identifiers from the rendering at the second device.

### TECHNICAL BACKGROUND

The proliferation of devices capable of information retrieval and presentation has vastly increased the possible avenues for consumption of content. A wide variety of devices are available, ranging in size, processing power, storage capability. In addition, many of such devices are capable of accessing data networks and sending and receiving data, including content over data networks. Experience demonstrates that content consumption begets additional content consumption, as interest in related topics content is spurred, and in response to demand the amount and type of content available has increased. One challenge presented by the proliferation of devices and content is management of content of interest and the devices for its consumption.

### OVERVIEW

In operation, a code associated with first content is received at a computing node from a first device, and the code is stored in a profile at the computing node. A plurality of other computing nodes are searched for one or more additional content associated with the code based on the first content. Content identifiers associated with the one or more additional content are stored in the profile and in a content table which associates the code with each of the content identifiers. Each of the content identifiers stored in the profile are organized based on the profile, and a rendering of the organized content identifiers is provided to a second device. The one or more additional content is sent to the second device in response to a selection of at least one of the content identifiers from the rendering at the second device.

### BRIEF DESCRIPTION OF THE DRAWINGS

FIG. 1 illustrates an exemplary communication system for managing content.

FIG. 2 illustrates an exemplary method of managing content.

FIGS. 3 and 4 illustrate an exemplary first device.

FIG. 5 illustrates another exemplary communication system for managing content.

FIG. 6 illustrates another exemplary method for managing content.

FIG. 7 illustrates an exemplary computing node.

### DETAILED DESCRIPTION

In operation, a code associated with a first content is received at a computing node from a first device. Based on the code associated with the first content, a plurality of other computing nodes are searched for additional content. Each of the additional content has an associated content identifier, and the content identifiers are stored in a profile at the computing node and in a content table at the computing node. The content table associates the code with each of the content identifiers. Each of the content identifiers stored in the profile are organized based on the profile, and a rendering of the organized content identifiers is provided to a second device based on a device identifier of the second device. In response to a selection of at least one of the content identifiers from the rendering at the second device, the one or more additional content is directed to be sent to the second device to be displayed at the second device.

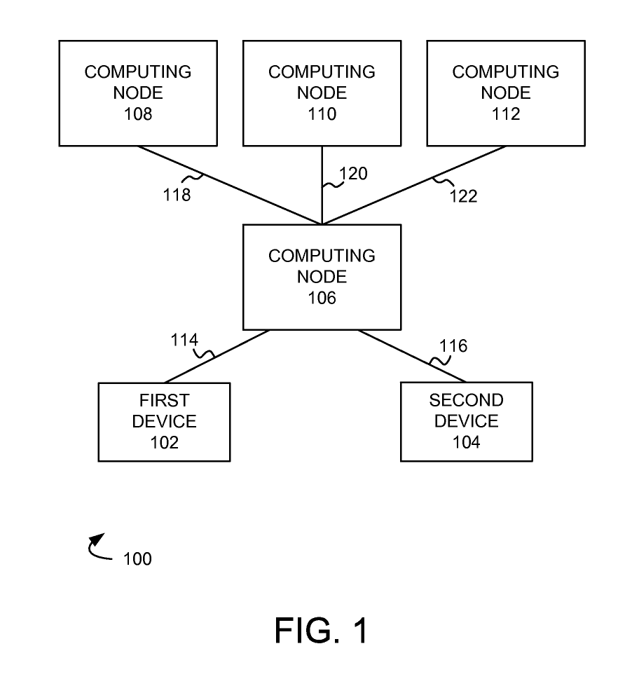

FIG. 1 illustrates an exemplary communication system 100 for managing content comprising first device 102, second device 104, and computing nodes 106, 108, 110, and 112. First device 102 and second device 104 are in communication with computing node 106 over communication links 114 and 116, respectively. Computing node 106 is also in communication with computing nodes 108, 110 and 112, over communication links 118, 120 and 122, respectively.

Examples of first device 102 and second device 104 can include a cell phone, a smart phone, a computing platform such as a laptop, palmtop, or tablet, a personal digital assistant, a television or other display device, a household appliance, an internet access device, or other device capable of wired or wireless communication and the storage of data, including combinations thereof.

Computing node 106 is a network element which can comprise a processor and associated circuitry to execute or direct the execution of computer-readable instructions for managing content. Computing node 106 can retrieve and execute software from storage, which can include a disk drive, flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Computing node 106 can communicate with first device 102 and second device 104, as well as with computing nodes 108, 110 and 112.

Computing nodes 108, 110 and 112 are also network elements which can comprise a processor and associated circuitry to execute or direct the execution of computer-readable instructions for managing content. Analogous to computing node 106, computing nodes 108, 110 and 112 can retrieve and execute software from storage, which can include a disk drive, flash drive, memory circuitry, or some other memory device, and which can be local or remotely accessible. Computing nodes 108, 110 and 112 may store, or have access to storage which stores, content for consumption by devices such as first device 102 and second device 104.

Communication links 114, 116, 118, 120 and 122 can be wired or wireless communication links. Wired communication links can be, for example, twisted pair cable, coaxial cable or fiber optic cable, or combinations thereof. Wireless communication links can be a radio frequency, microwave, infrared, or other similar signal. Wired and wireless communication links can use an appropriate communication protocol. Wired communication protocols that may be utilized by communication system 100 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM), or combinations thereof. Wireless communication links can be a radio frequency, microwave, infrared, or other similar signal, and can use a suitable communication protocol, for example, code division multiple access (CDMA) 1xRTT, Universal Mobile Telecommunications System (UMTS), High-Speed Packet Access (HSPA), Evolution Data Optimized (EV-DO), EV-DO rev. A, Global System for Mobile telecommunications (GSM), Code Division Multiple Access (CDMA), Worldwide Interoperability for Microwave Access (WiMAX), or Long Term Evolution (LTE), or combinations thereof.

Other network elements may be present to facilitate communication in communication system 100 which are omitted for clarity, including additional computing nodes, routers, gateways, and physical and/or wireless data links, and in the case of wireless communications systems may further include base stations, base station controllers, gateways, mobile switching centers, dispatch application processors, and location registers such as a home location register or visitor location register.

In an embodiment, a code associated with a first content is received at computing node 106 from first device 102. Based on the code associated with the first content, the plurality of other computing nodes 108, 110, 112 are searched for additional content. Each of the additional content has an associated content identifier, and the content identifiers are stored in a profile at computing node 106 and in a content table at computing node 106. The content table associates the code with each of the content identifiers. Each of the content identifiers stored in the profile are organized based on the profile, and a rendering of the organized content identifiers is provided to second device 104 based on a device identifier of second device 104. In response to a selection of at least one of the content identifiers from the rendering at second device 104, the one or more additional content is directed to be sent to second device 104 to be displayed at second device 104.

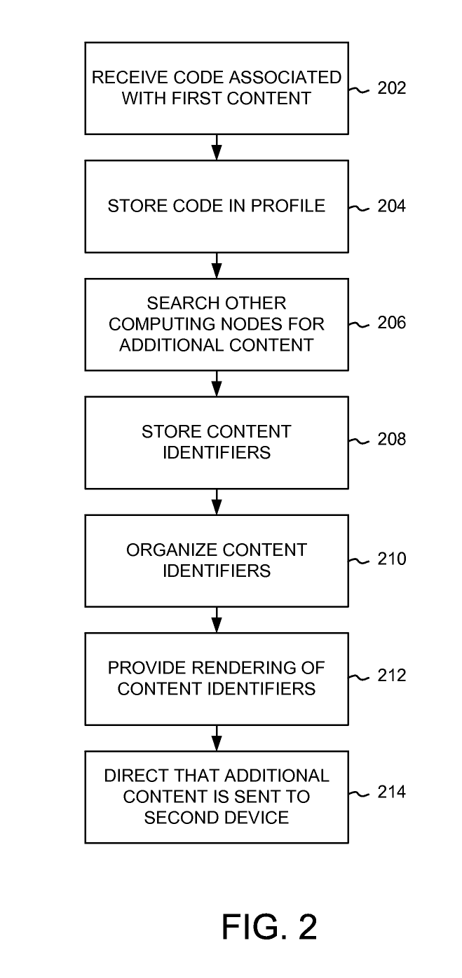

FIG. 2 illustrates an exemplary method of managing content. In operation 202, a code is received at computing node 106 from first device 102. The received code is associated with first content. For example, the first content can include content rendered at first device 102. Examples of content rendered at first device 102 can include text, image, video, audio, multimedia, or other information, including combinations thereof. The code can be electronic data or metadata associated with content rendered at first device 102. The code can be an identifier of the first content, or the code can be associated with descriptors of the first content. Descriptors can be general in nature, such as a topic, a genre, a style (of music or art or literature, for example), a geographic area, a time period or historical period, and the like. Descriptors can also be more specific, such as a company, a brand, a specific person associated with the first content (for example, an artist, an actor, an author, a producer, a director, a writer, a designer, and so forth), a title of a work, and the like. Other examples of descriptors, including combinations of the foregoing, are also possible.

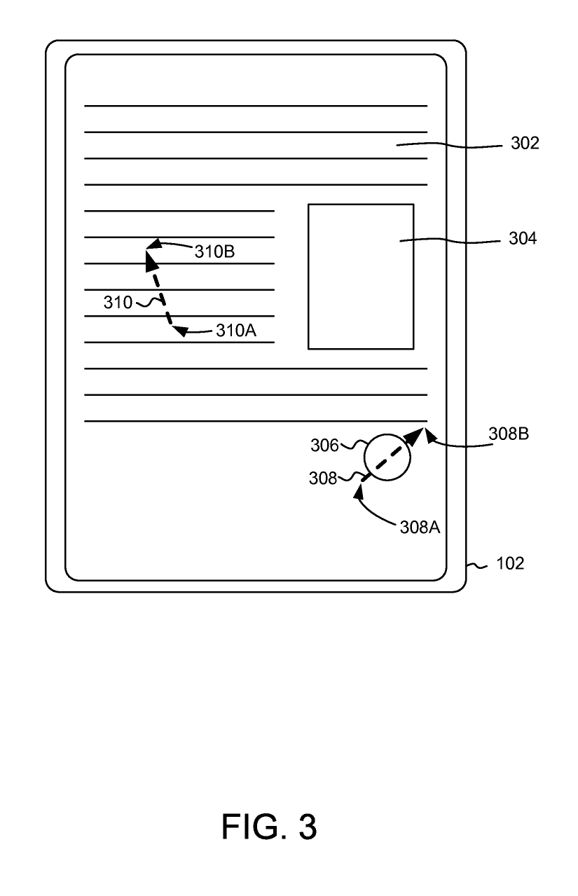

In an embodiment, first content can be rendered at first device 102 along with an indication of the associated code, and when first content is rendered at first device 102 a user can interact with the indication of the associated code such that the code is sent from first device 102 to computing node 106. The indication is typically text, an image, or combinations thereof. First device 102 can include a user interface to receive an input, comprising keys, buttons, sliders, touch sensitive panels and displays, and combinations thereof, to permit interaction with the indication. In an embodiment, an interaction with the indication comprises receiving an input at a touch sensitive user interface comprising detecting a touch input from approximately a first point on the user interface to approximately a second point on the user interface. Other examples of interaction with the indication are also possible. FIG. 3 illustrates an exemplary first device 102 displaying first content comprising an article 302 with an accompanying image 304 (such as a photograph), and also displaying indication 306 of a code associated with the first content. It will be appreciated that the exemplary article 304 and image 304 are not limiting, and a variety of first content can be displayed at first device 102. Indication 306 can comprise text, an image, or combinations thereof, and can be interacted with as described above. An exemplary interaction 308 is illustrated in FIG. 3, comprising an input at a touch sensitive user interface of first device 102 from approximately first point 308A on the user interface to approximately second point 308B on the user interface. The illustrated interaction 308 is intended to be exemplary and not limiting, and it will be recognized that an input can comprise numerous other examples and variations thereof.

In an embodiment, at least a portion of the detected input corresponds with a location of indication 306 on the display of first device 102, as illustrated in FIG. 3. However, this is not required, and indication 306 can serve as an indication that, for example, article 302 and/or image 304 are enabled for an interaction (such as interaction 310) comprising, for example, an input at a touch sensitive user interface of first device 102 from approximately first point 310A on the user interface to approximately second point 310B on the user interface, where at least a portion of the detected input corresponds with a location of article 302 on the display of first device 102. A similar interaction is also possible with respect to image 304. In an embodiment, the first content can comprise a first portion (such as article 302) associated with a first code, and a second portion (such as image 304) associated with a second code. Interaction with the first portion (for example, interaction 310) can designate the first code to be sent to computing node 106, and interaction with the second portion (for example, an interaction with image 304 analogous to interaction 310) can designate the second code to be sent to computing node 106. The first code and the second code can be associated with different additional content, as further described below. The first content can further comprise a plurality of portions, each associated with a different code. A portion of first content can comprise a sub-section of first content (such as a paragraph or a section of text, or a period of time of a video or audio presentation); a title (of an article or of an image, for example); a by-line, an author name or an artist name; or some other portion of first content.

Indication 306 can be presented in a variety of ways, for example, separate from the first content, adjacent to the first content, superimposed on the first content, or embedded in the first content, to name a few. For example, indication 306 can be presented as an indication in a margin, header, title, title bar, etc. (of either the first content, or, in an embodiment, of an application displaying the first content) that the rendered first content is enabled for interaction. Indication 306 can be static or dynamic (such as moving, blinking, changing, morphing, and the like).

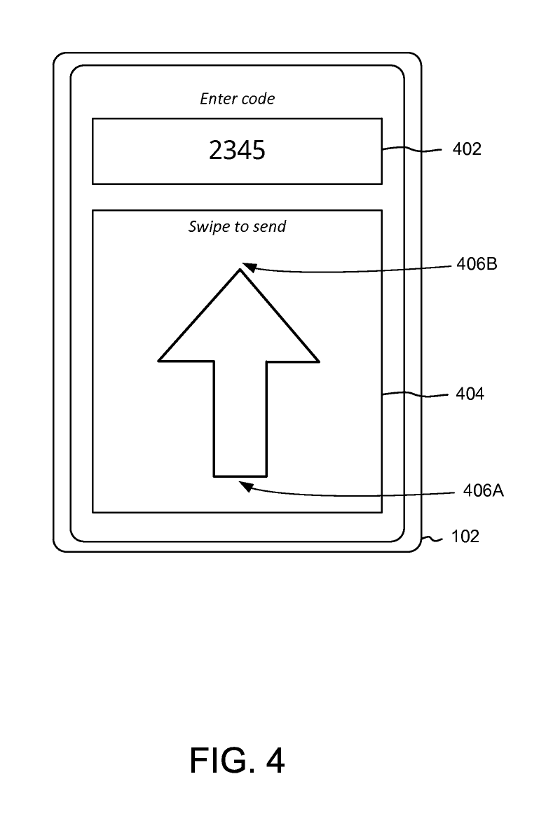

First content can also comprise content displayed on another device, such as a television, as well as content in printed form. The received code can be a code received at a user interface of first device 102 and sent from first device 102 to computing node 106. As one example, an article in a magazine may include a code, which can be provided to first device 102 and sent by first device 102 to computing node 106. As another example, first content can be displayed on a television together with a code, and the code can be provided to first device 102 and sent and sent by first device 102 to computing node 106. In yet another example, first content comprising a public advertisement (examples of which include a billboard, a placard, and a bus-mounted advertisement, which can comprise a static image or a large format electronic display) can be displayed together with a code, which can be provided to first device 102 and sent by first device 102 to computing node 106. Other variations and combinations are also possible. FIG. 4 illustrates an exemplary first device 102 comprising a first input area 402 to receive a code (such as the illustrated four-digit code) and a second input area 404 to receive an input comprising a command to send the received code to computing node 106. An exemplary input is illustrated in FIG. 4 comprising an input at a touch sensitive user interface of first device 102 from approximately first point 406A on the user interface to approximately second point 406B on the user interface. The illustrated input is intended to be exemplary and not limiting, and it will be recognized that an input can comprise numerous other examples and variations thereof.

Returning to FIG. 2, in operation 204, the received code is stored at computing node 106 in a profile. Computing node 106 can comprise a plurality of profiles, for example, user profiles, in which received codes can be stored. A user profile can also include an indication of one or more associated devices, such as first device 102 and second device 104. In an embodiment, when a code is received from first device 102, the code can be stored at computing node 106 in a profile associated with first device 102.

In operation 206, a plurality of other computing nodes are searched for one or more additional content based on the code associated with the first content. Each of the one or more additional content has an associated content identifier to identify the additional content. For example, a received code can be associated with an article about running, and additional content can be related to running, for example, an article about running technique, a video of famous city marathons or Olympic race performances, an advertisement for high performance running shoes, and the like. As another example, a received code can be associated with a documentary about music, and additional content can include information about a featured musician, an article providing a history of music, examples of music from the documentary, music and/or musicians related to the music or musicians in the documentary, and the like. Other examples, variations, and combinations thereof are also possible. The one or more additional content has an associated content identifier to identify the additional content, which can be, for example, a uniform resource locator (URL), or the content identifier can be some other identifier to distinguish or identify the additional content.

In operation 208, each of the content identifiers of the one or more additional content are stored in the profile and in a content table which associates the code with each of the content identifiers. The content identifiers which are stored in the profile can be accessed by a device associated with the profile, such as first device 102 and second device 104. Additionally, computing node 106 can include a content table which comprises an association between the received code and the content identifiers of the one or more additional content. In an embodiment, the content table of computing node 106 can be searched based on a received code in addition to or alternative to searching the plurality of other computing nodes. For example, when a code is received from first device 102, the content table of computing node 106 can be searched, and the plurality of other computing nodes can be searched. The plurality of other computing nodes can be searched, for example, if no associations of the code are found in the content table, or if a number of found associations of the code in the content table do not meet a threshold, or if an instruction is received to search the plurality of other computing nodes (for example, from first device 102). Other examples are also possible.

In operation 210, each of the content identifiers stored in the profile are organized based on the profile. The profile can comprise organizing preferences which can be used to organize the content identifiers stored in the profile. For example, organizing preferences can specify that the content identifiers should be organized, for example, by date created, or by date modified, or most recent first or last. Organizing preferences can also indicate that content indicators should be organized by popularity (such as most popular first or last), or by alphabetical order, or by the name of the creator, or by topic or genre, or by title. Organizing preferences can also indicate that the content identifiers should be randomly shuffled or arranged. Other examples of organizing preferences are also possible.

In operation 212, a rendering of the organized content identifiers is presented to a second device based on a device identifier of the second device. For example, when the content identifiers stored in the profile are organized according to the profile, a rendering of the organized content identifiers can be presented to second device 104. Second device 104 can be associated with the profile at computing node 106, and can access the profile and information stored therein, such as the content identifiers. In an embodiment, the rendering of the content identifiers comprises the content identifiers and instructions for their display on second device 104. The rendering can also be an image including the content identifiers which is provided to second device 104. The rendering can include the content identifiers, or it can be an indicator or other information referring to the content identifiers, such as a short title, an image, or some other indicator.

In operation 214, it is directed that one or more additional content is sent to the second device in response to a selection of at least one of the content identifiers from the rendering at the second device. For example, a selection can be received at second device 104 corresponding with one or more additional content referred to by the rendering of the organized content identifiers. Second device 104 can include a user interface to receive an input, comprising keys, buttons, sliders, touch sensitive panels and displays, remote controllers comprising keys, buttons, sliders, touch sensitive panels and displays, and combinations thereof, to permit receipt of a selection. When the selection is received from second device 104, computing node 106 can direct that one or more additional content is sent to the second device. For example, computing node 106 can direct that another computing node, such as computing node 108, 110 and/or 112, send the one or more additional content to second device 104. As another example, computing node 106 can also provide instructions to second device 104 for the retrieval of the one or more additional content from computing node 108, 110, and/or 112. As yet another example, computing node 106 can obtain the one or more additional content from computing node 108, 110, and/or 112 and provide the one or more additional content to second device 104.

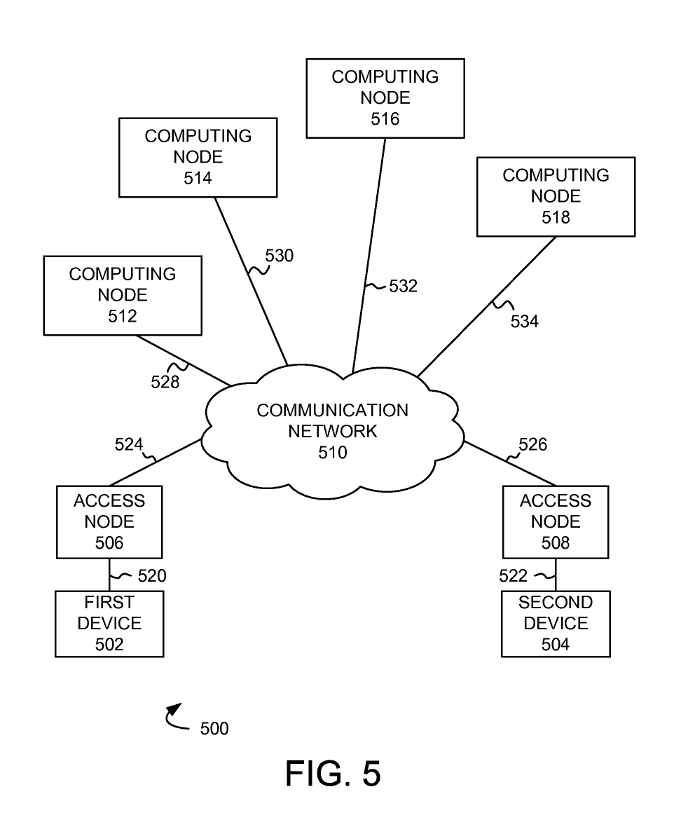

FIG. 5 illustrates another exemplary communication system 500 for managing content comprising first device 502, second device 504, access nodes 506 and 508, communication network 510, and computing nodes 512, 514, 516 and 518. Examples of first device 502 and second device 504 can include a cell phone, a smart phone, a computing platform such as a laptop, palmtop, or tablet, a personal digital assistant, a television or other display device, a household appliance, an internet access device, or other device capable of wired or wireless communication and the storage of data, including combinations thereof. First device 502 is in communication with access node 506 over communication link 506, and second device 504 is in communication with access node 508 over communication link 522. Access nodes 506 and 508 are in communication with communication network 510 over communication links 524 and 526, respectively. Communication network 510 is also in communication with computing nodes 512, 514, 516 and 518 over communication links 528, 530, 532 and 534, respectively.

Access nodes 506 and 508 can provide communications to first device 502 and second device 504, respectively. Examples of access nodes 506 and 508 include wireless devices employing wireless fidelity (WiFi), Bluetooth, or similar communication protocols, and wired devices such as a wired router or similar device, including combinations thereof. Other examples of access nodes 506, 508 include network nodes capable of providing wireless communications to wireless devices 502 and 504 including, for example, a base transceiver station, a radio broadcast station, an eNodeB device, or an enhanced eNodeB device.

Communication network 510 can be a wired and/or wireless communication network. Communication network 510 can comprise processing nodes, routers, gateways, and physical and/or wireless data links for carrying data among various network elements, and combinations, thereof, and can include a local area network, a wide area network, and an internetwork (including the Internet). Wired network protocols that may be utilized by communication network 510 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 510 may also comprise a wireless network, including base stations, wireless communication nodes, telephony switches, internet routers, network gateways, computer systems, communication links, or some other type of communication equipment, and combinations thereof. Wireless network protocols that may be utilized by communication network 106 may comprise code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX).

Computing node 512 is a network element which can comprise a processor and associated circuitry to execute or direct the execution of computer-readable instructions for managing content. Computing node 512 can retrieve and execute software from storage, which can include a disk drive, flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Computing node 512 can communicate with first device 502 via access node 506 and with second device 504 via access node 508, as well as with computing nodes 514, 516, and 518.

Computing nodes 514, 516, and 518 are also network elements which can comprise a processor and associated circuitry to execute or direct the execution of computer-readable instructions for managing content. Analogous to computing node 512, computing nodes 514, 516, and 518 can retrieve and execute software from storage, which can include a disk drive, flash drive, memory circuitry, or some other memory device, and which can be local or remotely accessible. Computing nodes 514, 516, and 518 may store, or have access to storage which stores, content for consumption by devices such as first device 502 and second device 504.

Communication links 520, 522, 524, 526, 528, 530, 532 and 534 can be wired or wireless communication links. Wired communication links can be, for example, twisted pair cable, coaxial cable or fiber optic cable, or combinations thereof. Wireless communication links can be a radio frequency, microwave, infrared, or other similar signal, and can use a suitable communication protocol, including the communication protocols described above with regard to communication network 510. Wired communication protocols that may be utilized by communication system 500 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM), or combinations thereof. Wireless communication links can be a radio frequency, microwave, infrared, or other similar signal, and can use a suitable communication protocol, for example, code division multiple access (CDMA) 1xRTT, Universal Mobile Telecommunications System (UMTS), High-Speed Packet Access (HSPA), Evolution Data Optimized (EV-DO), EV-DO rev. A, Global System for Mobile telecommunications (GSM), Code Division Multiple Access (CDMA), Worldwide Interoperability for Microwave Access (WiMAX), or Long Term Evolution (LTE), as well as short range wireless protocols conforming to the IEEE 802.11 (e.g., WiFi, WLAN, and the like) and IEEE 802.15 (e.g., WPAN, Bluetooth, ZigBee, and the like) standards, Infrared Data Association (IrDA) standards, and combinations thereof.

Other network elements may be present to facilitate communication in communication system 500 which are omitted for clarity, including additional computing nodes, routers, gateways, and physical and/or wireless data links, and in the case of wireless communications systems may further include base stations, base station controllers, gateways, mobile switching centers, dispatch application processors, and location registers such as a home location register or visitor location register.

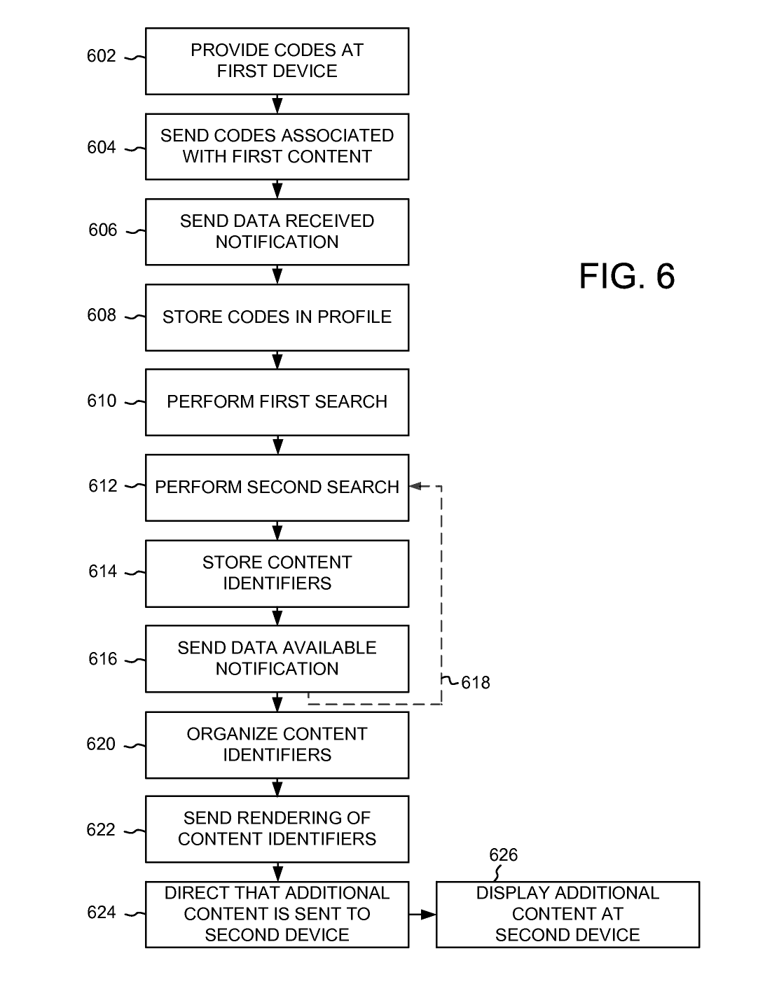

FIG. 6 illustrates another exemplary method for managing content. In operation 602, first content is rendered on first device 502, and a first code associated with a first portion of the first content and a second code associated with a second portion of the first content are provided to first device 502. Examples of content rendered at first device 502 comprise text, image, video, audio, multimedia, or other information, including combinations thereof. The first and second codes can be electronic data or metadata associated with content rendered at first device 502. The first and second codes can be identifiers of the first content, or the codes can be associated with descriptors of the first content. First content can be rendered at first device 502 along with an indication of an associated code, and when first content is rendered at first device 102 a user can interact with the indication of the associated code, or with a portion of the first content, such that the code is sent from first device 502 to computing node 512.

Interaction with a first portion of the first content, or with an indication of the first code, can designate the first code to be sent to computing node 512, and interaction with a second portion of the first content, or with an indication of the second code, can designate the second code to be sent to computing node 512. The first code and the second code can be associated with different additional content, as may be found on computing nodes 512, 514, 516, and/or 518. A portion of first content can also include a sub-section of first content (such as a paragraph or a section of text, or a period of time of a video or audio presentation); a title (of an article or of an image, for example); a by-line, an author name or an artist name; or some other portion of first content, and each sub-section can be associated with a different code. An indication of the first code and the second code can be presented statically or dynamically, for example, separate from the first content, adjacent to the first content, superimposed on the first content, embedded in the first content, as well as in a margin, header, title, title bar, and the like, to indicate that the rendered first content is enabled for interaction.

In operation 604, the first code is sent from first device 502 to computing node 512 based on an interaction with the first portion of the first content, and the second code is sent from first device 502 to computing node 512 based on an interaction with the second portion of the first content. First device 502 can receive the interactions at a user interface of the device. In an embodiment, an interaction with an indication, or with a portion of the first content, comprises receiving an input at a touch sensitive user interface comprising detecting a touch input from approximately a first point on the user interface to approximately a second point on the user interface. Other examples of interaction with an indication, or with a portion of the first content, are also possible. When the codes are received at computing node 512, a data received notification can be sent from computing node 512 to first device 502 to notify first device 502 of the receipt of the codes at computing node 512.

The first code and the second code are stored at computing node 512 in a profile (operation 608). Computing node 512 can comprise a plurality of profiles, for example, user profiles, in which received codes can be stored. A user profile can also include an indication of one or more associated devices, such as first device 502 and second device 504. In an embodiment, when a first and/or second code is received from first device 502, the code can be stored at computing node 512 in a profile associated with first device 502.

Based on the received codes, a first search is performed for one or more additional content associated with the codes (operation 610). The first search can be performed at computing node 512 by searching a content table of computing node 512 for content identifiers of one or more additional content which may be stored at the content table and which may be associated with a received code. A second search is also performed based on the received first and second codes (operation 612). The second search can be performed at computing nodes 514, 516, and/or 518 for one or more additional content based on the first and/or second codes based associated with the first content rendered on the first device. For example, a received first or second code can be associated with an article about a particular topic, and additional content can be related to the topic, for example, an article or audiovisual presentation about the topic, an advertisement related to the topic, a history or other background information about the topic, information about related topics, and the like. The content identifiers of the additional content are stored in the content table and in the profile (operation 614). In an embodiment, the content table associates the first code with additional content searched for based on the first code, and associates the second code with additional content searched for based on the second code.

When additional content is found, a data available notification can be sent from computing node 512 to first device 502. In an embodiment, a data available notification can be sent to second device 504 in addition to, or as an alternative to, sending a data available notification to first device 502. A data available notification can comprise for example, text, an image, a sound, a tactile indication, or combinations thereof.

The second search of computing nodes 514, 516, 518 can be periodically re-performed (operation 618). For example, when a code or codes are stored in the profile at computing node 512, the second search can be re-performed when a re-performance criteria is met, for example, after a predetermined period of time, or when a command is received to re-perform the second search, or when a number of content indicators stored in the profile and/or at the content table does not meet a threshold, or combinations thereof. Other criteria for re-performing the second search are also possible. When additional content is found based on a re-performed second search, content identifiers of the additional content can be stored in the profile and in the content table, and a data available notification can be sent from computing node 512 to first device 502.

In operation 620, each of the content identifiers stored in the profile are organized based on the profile and the first and second codes. The profile can comprise organizing preferences which can be used to organize the content identifiers stored in the profile. For example, organizing preferences can specify that the content identifiers should be organized by date created, or by date modified, for example, most recent first or last. Organizing preferences can also indicate that content indicators should be organized by popularity (such as most popular first or last), or by alphabetical order, or by the name of the creator, or by topic or genre, or by title. Organizing preferences can also indicate that the content identifiers should be randomly shuffled or arranged. Other examples of organizing preferences are also possible.

In an embodiment, the profile can further comprise additional information about first device 502 and second device 504, including a location of first device 502 and second device 504, an identifier of first device 502 and second device 504, a rendering format for first device 502 and second device 504, a plurality of user preferences, and a plurality of organizing preferences. Content identifiers can be organized according to a location of first device 502 and/or second device 504, for example, to give priority to additional content related to the location of the first and/or second device. User preferences can also be used to organize the content identifiers, for example to give preference to certain types of content identifiers, or to reduce a priority of certain types of content identifiers, or to eliminate from the organization certain types of content identifiers.

In operation 622, a rendering of the organized content identifiers based on a device identifier of the second device is sent to second device 504. For example, when the content identifiers stored in the profile are organized according to the profile, a rendering of the organized content identifiers can be presented to second device 504. Second device 504 can be associated with the profile at computing node 512, and can access the profile and information stored therein, such as the content identifiers. In an embodiment, the rendering of the content identifiers comprises the content identifiers and instructions for their display on second device 504. The rendering can also be an image including the content identifiers which is provided to second device 504. The rendering can include the content identifiers, or it can be an indicator or other information referring to the content identifiers, such as a short title, an image, or some other indicator.

In operation 624, one of the plurality of computing nodes is directed to send the one or more additional content to the second device in response to a selection of the one of the content identifiers from the rendering. For example, a selection can be received at second device 504 corresponding with one or more additional content referred to by the rendering of the organized content identifiers. Second device 504 can include a user interface to receive an input, comprising keys, buttons, sliders, touch sensitive panels and displays, remote controllers comprising keys, buttons, sliders, touch sensitive panels and displays, and combinations thereof, to permit receipt of a selection. When the selection is received from second device 504, computing node 512 can direct that one or more additional content is sent to the second device. For example, computing node 512 can direct that another computing node, such as computing node 514, 516 and/or 518, send the one or more additional content to second device 512. When the additional content is received at second device 504, the additional content is displayed at second device 504 (operation 626).

In an embodiment, computing node 512 can direct that the one or more additional content is to be sent to the second device in a format according to an identifier for the second device in response to a selection of at least one of the content identifiers from the rendering at the second device. For example, the profile can include an identifier of first device 502 and second device 504, as well as a rendering format for first device 502 and second device 504. In an embodiment, computing node 512 directs that the one or more additional content is sent to second device 504 in response to a selection of at least one of the content identifiers from the rendering at the second device in a format according to the identifier for the second device.

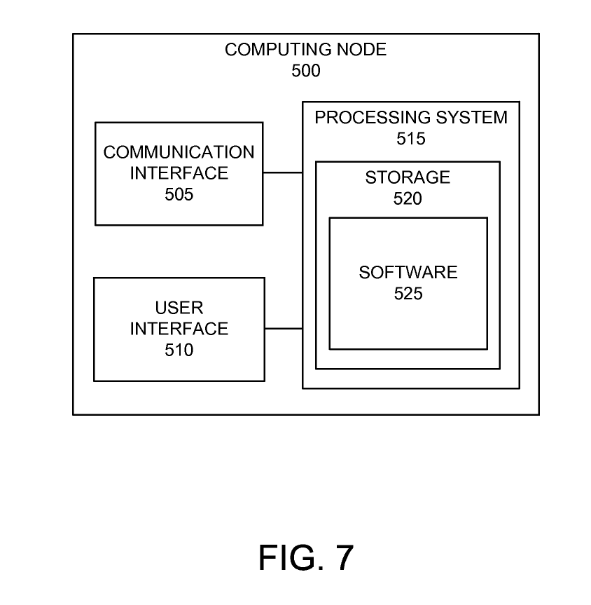

FIG. 7 illustrates an exemplary computing node 700 in a communication system. Computing node 700 comprises communication interface 705, user interface 710, and processing system 715 in communication with communication interface 705 and user interface 710. Processing system 715 includes storage 720, which can comprise a disk drive, flash drive, memory circuitry, or other memory device. Storage 720 can store software 725 which is used in the operation of the computing node 700. Storage 720 may include a disk drive, flash drive, data storage circuitry, or some other memory apparatus. Software 725 may include computer programs, firmware, or some other form of machine-readable instructions, including an operating system, utilities, drivers, network interfaces, applications, or some other type of software. Processing system 715 may include a microprocessor and other circuitry to retrieve and execute software 725 from storage 720. Computing node 700 may further include other components such as a power management unit, a control interface unit, etc., which are omitted for clarity. Communication interface 705 permits computing node 700 to communicate with other network elements. User interface 710 permits the configuration and control of the operation of computing node 700. Examples of computing node 500 include computing node 106 and computing node 512. Computing node 500 can also be an adjunct or component of a network node or other network element in a communication system

The exemplary systems and methods described herein can be performed under the control of a processing system executing computer-readable codes embedded on a computer-readable recording medium or on communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, signals which modulate carrier waves transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method for managing content in a computing system, comprising:
receiving at a computing node from a first device a code associated with a first content and storing the code in a profile at the computing node;
searching a plurality of other computing nodes for one or more additional content based on the code associated with the first content, wherein each of the one or more additional content has an associated content identifier;
storing each of the content identifiers in the profile and in a content table which associates the code with each of the content identifiers;
organizing each of the content identifiers stored in the profile based on the profile;
providing a rendering of the organized content identifiers to a second device, wherein the rendering is based on a device identifier of the second device; and
directing that the one or more additional content is sent to the second device in response to a selection of at least one of the content identifiers from the rendering at the second device.

2. The method of claim 1, wherein the first content is rendered on the first device.

3. The method of claim 1, wherein directing further comprises:
directing one of the plurality of computing nodes to send the one or more additional content to the second device in response to a selection of the one of the content identifiers from the rendering at the second device.

4. The method of claim 1, wherein searching further comprises:
performing a first search of the content table for content identifiers associated with the code; and
performing a second search of other computing nodes for one or more additional content based on the code associated with the first content rendered on the first device, wherein each of the one or more additional content has an associated content identifier.

5. The method of claim 4, further comprising
re-performing the second search of other computing nodes for one or more additional content based on the code associated with the first content rendered on the first device when a re-performance criteria is met.

6. The method of claim 1, further comprising sending a data received notification by the computing node to the first device on receipt of the data at the computing node

7. The method of claim 1, further comprising sending a data available notification by the computing node to the first device and the second device.

8. The method of claim 1, wherein the one or more additional content comprises the first content.

9. The method of claim 1, wherein the profile further comprises at least one of a location of the first device and the second device, an identifier of the first device and the second device, a rendering format for the first device and the second device, a plurality of user preferences, and a plurality of organizing preferences.

10. The method of claim 1, wherein directing further comprises:
directing that the one or more additional content is sent to the second device in a format according to an identifier for the second device in response to a selection of at least one of the content identifiers from the rendering at the second device.

11. A method for managing content in a computing system, comprising:
providing at a first device a first code associated with a first portion of a first content and a second code associated with a second portion of the first content, wherein the first content is rendered on the first device;
sending from the first device to a computing node the first code based on an interaction with the first portion of the first content, and sending the second code based on an interaction with the second portion of the first content;
storing the first code and the second code in a profile at the computing node;
searching a plurality of other computing nodes for one or more additional content based on at least one of the first code and the second code associated with the first content rendered on the first device, wherein each of the one or more additional content has an associated content identifier;
storing each of the content identifiers in a content table and in the profile, wherein the content table associates the first code with additional content searched for based on the first code, and associates the second code with additional content searched for based on the second code;
organizing each of the content identifiers stored in the profile based on the profile and the first and second codes;
sending to a second device a rendering of the organized content identifiers, wherein the rendering is based on a device identifier of the second device;
directing one of the plurality of computing nodes to send the one or more additional content to the second device in response to a selection of the one of the content identifiers from the rendering; and
displaying the one of the one or more additional content at the second device.

12. The method of claim 11, wherein the first device and the second device are associated with the profile.

13. The method of claim 11, wherein directing further comprises:
directing based on the associations stored in the content table one of the plurality of computing nodes to send the one or more additional content to the second device in response to a selection of the one of the content identifiers from the rendering.

14. The method of claim 11, wherein the profile further comprises at least one of a location of the first device and the second device, an identifier of the first device and the second device, a rendering format for the first device and the second device, a plurality of user preferences, and a plurality of organizing preferences.

15. The method of claim 14, wherein directing further comprises:
directing that the one or more additional content is sent to the second device in response to a selection of at least one of the content identifiers from the rendering at the second device in a format according to the identifier for the second device.

16. A system for managing content in a computing system, comprising:
a computing node configured to:
receive from a first device a code associated with a first content and store the code in a profile at the computing node;
search a plurality of other computing nodes for one or more additional content associated with the code based on the first content, wherein each of the one or more additional content has an associated content identifier;
store each of the content identifiers in the profile and in a content table which associates the code with each of the content identifiers;
organize each of the content identifiers stored in the profile based on the profile;
provide a rendering of the organized content identifiers to a second device, wherein the rendering is based on a device identifier of the second device; and
direct that the one or more additional content is sent to the second device in response to a selection of at least one of the content identifiers from the rendering at the second device.

17. The system of claim 16, wherein the computing node is further configured to:
direct one of the plurality of computing nodes to send the one or more additional content to the second device in response to a selection of the one of the content identifiers from the rendering at the second device.

18. The system of claim 16, wherein the computing node is further configured to:
perform a first search of the content table for associations between content identifiers and the code; and
perform a second search of other computing nodes for one or more additional content associated with the code based on the first content rendered on the first device, wherein each of the one or more additional content has an associated content identifier.

19. The system of claim 16, wherein the profile further comprises at least one of a location of the first device and the second device, an identifier of the first device and the second device, a rendering format for the first device and the second device, a plurality of user preferences, and a plurality of organizing preferences.

20. The system of claim 16, wherein the computing node is further configured to:
direct that the one or more additional content is sent to the second device in a format according to an identifier for the second device in response to a selection of at least one of the content identifiers from the rendering at the second device.
